(19) United States
(12) Patent Application Publication
(10) Pub. No.: US 2018/0164891 A1
(43) Pub. Date: Jun. 14, 2018

(54) GESTURE RECOGNITION SYSTEM AND GESTURE RECOGNITION METHOD USING THE SAME

(71) Applicant: JinYu ZHANG, Shenzhen (CN)

(72) Inventor: JinYu ZHANG, Shenzhen (CN)

(73) Assignee: AAC Acoustic Technologies (Shenzhen) Co., Ltd., Shenzhen (SZ)

(21) Appl. No.: 15/416,435

(22) Filed: Jan. 26, 2017

(30) Foreign Application Priority Data
Dec. 9, 2016 (CN) 201611136285.7

(51) Int. Cl. G06F 3/01; G01S 15/06

(52) U.S. Cl. CPC G06F 3/017; G01S 15/06

(57) ABSTRACT

The present disclosure discloses a gesture recognition system. The gesture recognition system includes a processor configured to send a pulse signal and recognize corresponding hand gesture command according to an algorithm, an ultrasonic generator configured to receive the pulse signal sent by the processor and then send an ultrasonic wave, and a microphone including a signal pick-up unit configured to receive the ultrasonic wave reflected by a target object and generate a reflected signal and a signal processing unit configured to compare the reflected signal and the pulse signal so as to generate time data and frequency shift data, and then transmit the same to the processor. The present disclosure also provides a gesture recognition method. The gesture recognition system and the gesture recognition method using the system solve the problem of requirement on high-frequency sampling and data transmission, and thus high power consumption and large bandwidth occupation.

### TECHNICAL FIELD

The present disclosure relates to the field of acoustic technologies and, specifically, relates to a gesture recognition system and a gesture recognition method using the system.

### BACKGROUND

With the development of wireless communications, users of electronic products or devices (such as cell phones, earphones and computers and so on) are becoming more and more, and the requirements of users on the electronic products or devices are also becoming higher and higher.

In the relevant art, a microphone outputs complete ultrasonic audio signals, which needs high-frequency sampling and data transmission due to the high frequency of the ultrasonic frequency band, and thus consumes a large amount of power and occupies a large amount of system bandwidth.

Therefore, it is necessary to provide a new gesture recognition system.

### BRIEF DESCRIPTION OF DRAWINGS

Many aspects of the exemplary embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a structural block diagram of a gesture recognition system in accordance with an exemplary embodiment provided by the present disclosure.

### DESCRIPTION OF EMBODIMENTS

Technical solutions of embodiments of the present disclosure are clearly and completely described below with reference to accompanying drawings of the present disclosure, obviously, the embodiments described herein are merely part of the embodiments of the present disclosure rather than all the embodiments. Based on the embodiments in the present disclosure, all the other embodiments obtained by those skilled in the art without paying creative work shall fall into the protection scope of the present disclosure.

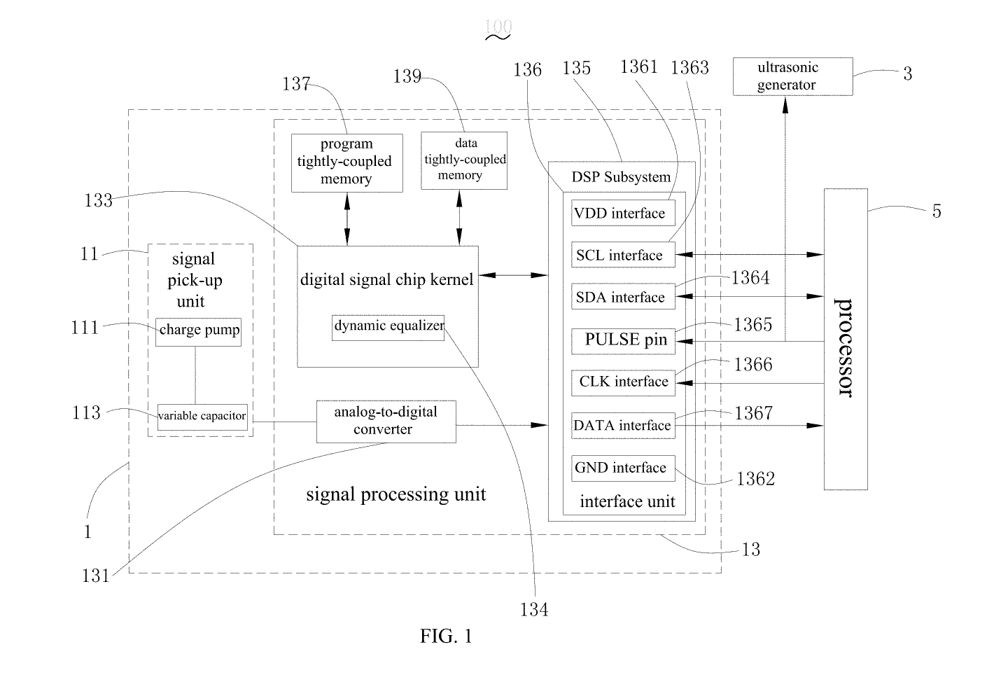

As shown in FIG. 1, a gesture recognition system 100 includes a microphone 1, an ultrasonic generator 3 and a processor 5 which is electrically connected with the microphone 1 and the ultrasonic generator 3, respectively. The processor 5 is configured to send a pulse signal and recognize a corresponding hand gesture command according to an algorithm; the ultrasonic generator 3 is configured to receive the pulse signal sent by the processor 5 and then send an ultrasonic wave; the microphone 1 includes a signal pick-up unit 11 and a signal processing unit 13 which is electrically connected with the signal pick-up unit 11 and the processor 5, respectively; the signal pick-up unit 11 is configured to receive the ultrasonic wave reflected by a target object (such as a human hand) and generate a reflected signal, the signal processing unit 13 is configured to compare the reflected signal with the pulse signal so as to generate time data and frequency shift data, and then transmit the time data and the frequency shift data to the processor 5.

The signal pick-up unit 11 includes a charge pump 111 and a variable capacitor 113 which is electrically connected with the charge pump 111 and the signal processing unit 13, respectively. In the present embodiment, the reflected signal is an analog signal.

The signal processing unit 13 includes an analog-digital converter 131, a digital signal chip kernel 133, a DSP subsystem 135, a program tightly-coupled memory 137 and a data tightly-coupled memory 139. The analog-digital converter 131 is electrically connected with the variable capacitor 113 and the DSP subsystem 135, respectively; the digital signal chip kernel 133 is electrically connected with the DSP subsystem 135, the program tightly-coupled memory 137 and the data tightly-coupled memory 139, respectively; the processor 5 is electrically connected with the DSP subsystem 135.

The analog-digital converter 131 is configured to convert the analog signal output by the signal pick-up unit 11 into a digital signal.

The digital signal chip kernel 133 includes a dynamic equalizer 134 and is configured to process the reflected signal and the pulse signal.

The DSP subsystem 135 includes an interface unit 136 and is configured to provide power supply management and input/output interfaces for the digital signal digital kernel 133.

The interface unit 136 includes a VDD interface 1361 and a GND interface 1362 which are configured for power supply management, and a SCL interface 1363, a SDA interface 1364, a PULSE pin 1365, a CLK interface 1366 and a DATA interface 1367 which are configured to be electrically connected with the processor 5, respectively.

The program tightly-coupled memory 137 is configured to store program and algorithm.

The data tightly-coupled memory 139 is configured to store data, and a characteristic curve of the dynamic equalizer 134 is stored in the data tightly-coupled memory 139. Specifically, when a microphone leaves factory, the characteristic curve data of the dynamic equalizer 134 is written into the data tightly-coupled memory 139 via the SCL interface 1363 and the SDA interface 1364 and is controlled via the SCL interface 1363 and the SDA interface 1364, i.e., starting of the dynamic equalizer 134 not only can improve the frequency response of the ultrasonic frequency band, but also allow a frequency response to reach a range of 100 Hz-20 kHz or more, which is advantageous in improving the ultrasonic response range of the microphone 1.

Further, after a single microphone is assembled into the integral set, calibration data can be obtained by calibrating a standard sound source.

It should be noted that, a high definition audio in general requires up to 16 kHZ.

Based on the gesture recognition system 100, the present disclosure further provides a gesture recognition method, including the following steps:

Step S1: providing a microphone 1, an ultrasonic generator 3 and a processor 5, the microphone 1 includes a signal pick-up unit 11 and a signal processing unit 13, the processor 5 sends a pulse signal and transmits the signal to the ultrasonic generator 3 and the signal processing unit 13. In the present embodiment, the processor 5 sends a pulse signal which is then input into the digital signal chip kernel 13 through the PULSE pin 1365.

Step S2: the ultrasonic generator 3 receives the pulse signal sent by the processor 5 and then sends an ultrasonic wave, the ultrasonic wave is reflected by a target object and then transmitted to the signal pick-up unit 11.

Step S3: the signal pick-up unit 11 generates a reflected signal and transmits the reflected signal to the signal processing unit 13.

Step S4: the signal processing unit 13 compares the reflected signal with the pulse signal so as to generate time data and frequency shift data, and transmits the time data and the frequency shift data to the processor 5.

Specifically, the analog-digital converter 131 coverts the analog signal generated by the signal pick-up unit 11 into the digital signal which is then input into the digital signal chip kernel 133, the digital signal chip kernel 133 obtains time data and frequency shift data by comparing the reflected signal and the pulse signal, and then transmits the time data and the frequency shift data back into the processor 5 through the SCL interface 1363 and the SDA 1364.

Step S5: the processor 5 recognizes a corresponding hand gesture command according to an algorithm.

The gesture recognition system and the gesture recognition method using the system provided by the present disclosure have the following beneficial effects:

The processor 5 sends a pulse signal, the ultrasonic generator 3 receives the pulse signal and then sends an ultrasonic wave, the ultrasonic wave is reflected by an target object and then is transmitted to the signal pick-up unit 11 where a reflected signal is then generated, the signal processing unit 13 compares the reflected signal with the pulse signal so as to generate time data and frequency shift data, and then transmits the time data and the frequency shift data to the processor 5, and the processor 5 recognizes a corresponding hand gesture command according to the algorithm, which not only merely needs to transmit the time data and the frequency shift data, but also reduces the power consumption and the bandwidth occupation.

The above are merely embodiments of the present disclosure, it should be noted that, those skilled in the art can make further improvements without departing from the inventive concept of the present disclosure, however, those improvements shall all fall into the protection scope of the present disclosure.

What is claimed is:

1. A gesture recognition system, comprising:
a processor, configured to send a pulse signal and recognize a corresponding hand gesture command according to an algorithm;
an ultrasonic generator, configured to send an ultrasonic wave after receiving the pulse signal sent by the processor; and
a microphone, the microphone comprises a signal pick-up unit and a signal processing unit; the signal pick-up unit is configured to receive the ultrasonic wave reflected by a target object and generate a reflected signal; the signal processing unit is configured to compare the reflected signal with the pulse signal so as to generate time data and frequency shift data, and then transmit the time data and the frequency shift data to the processor.

2. The gesture recognition system as described in claim 1, wherein the signal processing unit comprises an analog-digital converter, a digital signal processor (DSP) subsystem, a digital signal chip kernel, a program tightly-coupled memory and a data tightly-coupled memory; the analog-digital converter is electrically connected with the signal pick-up unit and the DSP subsystem, respectively; the digital signal chip kernel is electrically connected with the DSP subsystem, the program tightly-coupled memory and the data tightly-coupled memory, respectively; the processor is electrically connected with the DSP subsystem.

3. The gesture recognition system as described in claim 2, wherein the DSP subsystem comprises an interface unit, the interface unit comprises a SCL interface, a SDA interface and a PULSE pin which are electrically connected with the processor, respectively.

4. The gesture recognition system as described in claim 2, wherein the digital signal chip kernel has a dynamic equalizer.

5. The gesture recognition system as described in claim 1, wherein the signal pick-up unit comprises a charge pump and a variable capacitor which is electrically connected with the charge pump and the signal processing unit, respectively.

6. A gesture recognition method, comprising:
step 1: providing a microphone, an ultrasonic generator and a processor, the microphone comprises a signal pick-up unit and a signal processing unit, the processor sends a pulse signal and transmits the pulse signal to the ultrasonic generator and the signal processing unit;
step 2: sending, by the ultrasonic generator, an ultrasonic wave after receiving the pulse signal sent by the processor; the ultrasonic wave is reflected by an target object and then transmitted to the signal pick-up unit;
step 3: generating, by the signal pick-up unit, a reflected signal and transmitting the reflected signal to the signal processing unit;
step 4: comparing , by the signal processing unit, the reflected signal with the pulse signal so as to generate time data and frequency shift data, and transmitting the time data and the frequency shift data to the processor;
step 5: recognizing, by the processor, a corresponding hand gesture command according to an algorithm.

7. The gesture recognition method as described in claim 6, wherein the signal processing unit comprises an analog-digital converter, a digital signal processor (DSP) subsystem, a digital signal chip kernel, a program tightly-coupled memory and a data tightly-coupled memory; the analog-digital converter is electrically connected with the signal pick-up unit and the DSP subsystem, respectively; the digital signal chip kernel is electrically connected with the DSP subsystem, the program tightly-coupled memory and the data tightly-coupled memory, respectively; the processor is electrically connected with the DSP subsystem.

8. The gesture recognition method as described in claim 7, wherein the DSP subsystem comprises an interface unit, the interface unit comprises a SCL interface, a SDA interface and a PULSE pin which are electrically connected with the processor, respectively.

9. The gesture recognition method as described in claim 7, wherein the digital signal chip kernel has a dynamic equalizer.

10. The gesture recognition method as described in claim 6, wherein the signal pick-up unit comprises a charge pump and a variable capacitor which is electrically connected with the charge pump and the signal processing unit, respectively.
